(19) United States
(12) Patent Application Publication
(10) Pub. No.: US 2009/0134146 A1
(43) Pub. Date: May 28, 2009

(54) Heating blocks

(75) Inventors: Hermann Hald, Weissach (DE); Klaus Funk, Ottobrunn (DE); Bernhard Heidenreich, Asperg (DE)

Correspondence Address: Lipsitz & McAllister, LLC, 755 MAIN STREET, MONROE, CT, 06468, US

(73) Assignee: Deutsches Zentrum fuer Luft- und Raumfahrt e.V., Koeln (DE)

(21) Appl. No.: 12/291,165

(22) Filed: Nov. 5, 2008

(30) Foreign Application Priority Data
Nov. 7, 2007 (DE) 10 2007 054 527.6

(51) Int. Cl. H05B 3/10

(52) U.S. Cl. 219/552

(57) ABSTRACT

In order, on the one hand, to achieve a high mechanical long-term stability of and, on the other hand, to have the possibility of guiding a stream of gas, in particular, a stream of gas consisting of a reactive process gas through a heating block for an apparatus for the thermal treatment of a substrate, in particular, a semiconductor substrate, wherein the apparatus has a space accommodating the substrate and the heating block on at least one side of the space accommodating the substrate, the substrate being treatable thermally by means of the heating block in a mechanically non-contact manner, it is suggested that the heating block be designed as a fiber composite member, that the fiber composite member be designed with passages for a stream of gas passing through it from one flat side to the other flat side.

The present disclosure relates to the subject matter disclosed in German application number 10 2007 054 527.6 of Nov. 7, 2007, which is incorporated herein by reference in its entirety and for all purposes.

### BACKGROUND OF THE INVENTION

The invention relates to a heating block for an apparatus for the thermal treatment of a substrate, in particular, a semiconductor substrate. The known, thermal treatment of substrates is carried out, in particular, for the purpose of performing every type of process in the substrates, in the case of semiconductor substrates, in particular, for the purpose of enabling thermally activatable processes to take place in the semiconductor substrates, for example, semiconductor wafers.

Apparatuses of this type for the thermal treatment of substrates are, for example, apparatuses for the rapid thermal treatment of substrates, wherein heat treatments with temperature variations of more than 50 K/sec., preferably temperature variations in the range of 100 K/sec. up to 1000 K/sec. are realized and wherein maximum temperatures of approximately 300° C. up to approximately 1300° C. are reached for a period of time in the range of approximately 1 to approximately 10 secs.

Such rapid heat treatments are used, for example, for the production of semiconductor components and serve the purpose, for example, of carrying out the following processes: electric activation of doping elements, defect healing, diffusion of chemical elements, oxidation of chemical elements, nitriding, siliconization, generation of high K anneals, performing epitaxy, carrying out chemical vapor deposition, material compaction, drying procedures for the purpose of thermal deoxidization as well as for the purpose of thermochemical oxidation.

In the case of such apparatuses for the thermal treatment of substrates, in particular, semiconductor substrates, a space accommodating the substrate is provided and a heating block on at least one side of the space accommodating the substrate, the substrate being treatable in the space accommodating the substrate by means of the heating block in a contact-less, thermal manner and, where applicable, with process gas.

The problem with such a heating block is, on the one hand, to achieve a high mechanical long-term stability and, on the other hand, to have the possibility of guiding a stream of gas, in particular, a stream of gas consisting of a reactive process gas through the heating block.

### SUMMARY OF THE INVENTION

This object is accomplished in accordance with the invention, in a heating block of the type described at the outset, in that the heating block is designed as a fiber composite member, that the fiber composite member is designed with passages for a stream of gas passing through it from one flat side to the other flat side.

The advantage of the solution according to the invention is to be seen, on the one hand, in the fact that, with it, a heating block is available which is mechanically stable over a long period of time and, in addition, has improved temperature equalization properties on account of the through-flow of gas.

A favorable solution provides for the fiber composite member to have a material which is non-reactive to the stream of gas in the area of its essential surfaces bordering on the stream of gas and so the heating block is in a position to guide the stream of gas which has a process gas, in particular, a reactive process gas in an optimum manner.

In this respect, it is particularly favorable when the fiber composite member has ceramic material in the area of the surfaces bordering on the stream of gas since ceramic material has the property of being non-reactive to a plurality of reactive process gases and, therefore, the process gases cannot cause any destruction in the area of the surfaces bordering on the stream of gas.

In principle, the entire fiber composite member could consist of ceramic material so that the surfaces bordering on the stream of gas also, automatically, consist of a ceramic material. Such a fiber composite member can be formed from fibers and matrix material which both consist of a ceramic material.

Since ceramic is, however, a very brittle material and has an appreciable thermal expansion, it is preferably provided for the surfaces bordering on the stream of gas to be the surfaces of ceramic layers of the fiber composite member and so it is possible to form the fiber composite member, beneath the ceramic layers, from a material which is less brittle so that the mechanical long-term stability of the heating block can be improved.

With respect to the thickness of the ceramic layers, no further details have so far been given.

One advantageous solution, for example, provides for the ceramic layers to have a thickness of at least approximately 1 μm, even better at least approximately 2 μm.

Furthermore, it is favorable, in order for the ceramic layers not to be too thick, when the ceramic layers have a thickness of at the most approximately 50 μm so that the tendency of the ceramic layers to form cracks is limited or reduced.

In this respect, it is particularly favorable when the flow cross sections formed by the passages vary between a central area of the heating block and outer areas of the heating block so that, as a result, it is possible to adapt the diffuse stream of gas which occurs in the area of the substrate to optimum flow ratios, in particular, to adapt it such that optimum flow and concentration ratios of process gas result in the area of the substrate.

One advantageous solution provides for the passages in the outer areas of the heating block to have a smaller flow cross section than the passages in the central area of the heating block.

With respect to the design of the passages, no further details have so far been given.

One advantageous solution, for example, provides for the passages to be realized in the fiber composite member by way of channels or bores introduced in a defined manner.

However, in order to obtain a stream of gas in the area of the substrate which is as diffuse as possible, it has proven to be advantageous when the passages are formed by pores and/or cracks in the fiber composite member. As a result, a large number of passages which have a very small cross section for the guidance of gas may be realized in the heating block and these result, on the other hand, in a diffuse stream of gas on the side of the substrate which has the advantage that it is very uniform and, therefore, does not lead to any great flow gradients at the surface of the substrate.

Furthermore, no additional details have been given with respect to the design of the fiber composite member itself.

In principle, the fibers in the fiber composite member could be arranged in a manner distributed statistically, wherein it is still possible to design the fiber composite member to be porous in such a manner that an adequate flow cross section for the stream of gas is made available by the pores and, where applicable, resulting cracks in such a fiber composite member.

A particularly favorable solution does, however, provide for the fibers in the fiber composite member to extend approximately along a preferential direction.

The provision of such a preferential direction has the advantage that, as a result, a course of the cracks in the fiber composite member can also be predetermined, at least approximately, since, in such a case, the cracks likewise extend approximately along the preferential direction.

It is particularly favorable, in order to achieve an optimum stream of gas from one flat side to the other flat side, when the preferential direction extends transversely to the flat sides of the heating block so that, as a result, it is possible to guide the stream of gas from one flat side of the heating block to the other flat side of the heating block since the cracks resulting in the case of such a preferential direction likewise extend from one flat side to the other and, therefore, make passages for the stream of gas available.

With respect to the design of the ceramic material itself, no further details have so far been given.

Oxidic and/or non-oxidic ceramics can expediently be used as ceramic materials.

For example, silicon nitride or aluminum nitride or aluminum oxide could be used as ceramic material.

Another, particularly advantageous ceramic material is silicon carbide.

Furthermore, no additional details have so far been given concerning the fibers of the fiber composite member. It is, for example, possible to design the fibers of the fiber composite member itself as ceramic fibers.

In this case, it is also expediently provided for the matrix material to be a ceramic material.

However, in order to achieve a good, mechanical long-term stability of the heating block, it has proven to be particularly advantageous when the fiber composite member comprises carbon fibers.

In the case where the fiber composite member comprises carbon fibers, it has likewise proven to be advantageous when the fiber composite member comprises carbon as matrix material since, as a result, a material is available, not only with respect to the fibers but also to the matrix material, which is far more advantageous with respect to its ductility than ceramic material and, therefore, causes no problems whatsoever with respect to the brittleness of the material and, therefore, the unexpected formation of cracks.

Particularly in the case where the carbon fibers and the matrix material consist of carbon, it has proven to be advantageous when the carbon is converted to silicon carbide at the surfaces bordering on the stream of gas. Such a layer consisting of silicon carbide therefore forms a protective layer against reactions with the process gas conveyed in the stream of gas.

Since such a heating block is normally used when a rapid heating up of the substrate can take place solely on account of the thermal mass of the heating block without its temperature varying appreciably, it is preferably provided for the heating block to have a thermal mass which is 5 times, even better 10 times and favorably 100 times the thermal mass of the substrate.

In addition, the invention relates to an apparatus for the thermal treatment of substrates, in particular, semiconductor substrates, comprising a space accommodating the substrate and a heating block, with which the substrate can be treated thermally in the space accommodating the substrate, on at least one side of the space accommodating the substrate.

In the case of such an apparatus, it is provided in accordance with the invention for the heating block is be designed in accordance with one or several of the features according to the invention which are described above.

Such a heating block allows an adequate, mechanical long-term stability and operational safety to be achieved with an apparatus of the type described above.

Such a heating block can, in this respect, be heated up in the most varied of ways.

One advantageous solution provides for the heating block to be heatable by a heating device in a mechanically non-contact manner.

Such a heating device which operates in a mechanically non-contact manner can, for example, be realized in that the heating device comprises heating lamps which heat up the heating block as a result of the radiation of heat, wherein either a direct heating of the heating block can take place or an indirect heating, namely by heating up a housing part bearing the heating block.

One solution provides for the heating device to comprise heat radiators.

Another, advantageous solution provides for the heating device to comprise an inductor which causes swirling flows in the heating block which result in the heating block being heated up.

A further, advantageous solution provides for the heating device to comprise a microwave generator which couples the heating energy into the heating block via microwaves.

Finally, a further possibility provides for the heating block to be heated up by way of bodily thermal contact with the heating device.

Such a solution provides, for example, for the heating block to be in direct or indirect bodily contact with a resistance heater so that the heating block can be heated up via bodily conduction of heat.

Additional features and advantages of the invention are the subject matter of the following description as well as the drawings illustrating several embodiments.

### BRIEF DESCRIPTION OF THE DRAWINGS

FIG. 1 shows a schematic, partial section through an apparatus for the thermal treatment of a substrate in accordance with a first embodiment;

FIG. 2 shows an enlarged section through the heating block in accordance with the first embodiment;

FIG. 3 shows a more enlarged sectional illustration of pores and/or cracks in the heating block according to FIG. 2;

FIG. 4 shows a section similar to FIG. 2 through a heating block in accordance with a second embodiment;

FIG. 5 shows a section similar to FIG. 1 through an apparatus in accordance with a third embodiment;

FIG. 6 shows a section similar to FIG. 1 through an apparatus in accordance with a fourth embodiment and

FIG. 7 shows a section similar to FIG. 1 through an apparatus in accordance with a fifth embodiment.

### DETAILED DESCRIPTION OF THE INVENTION

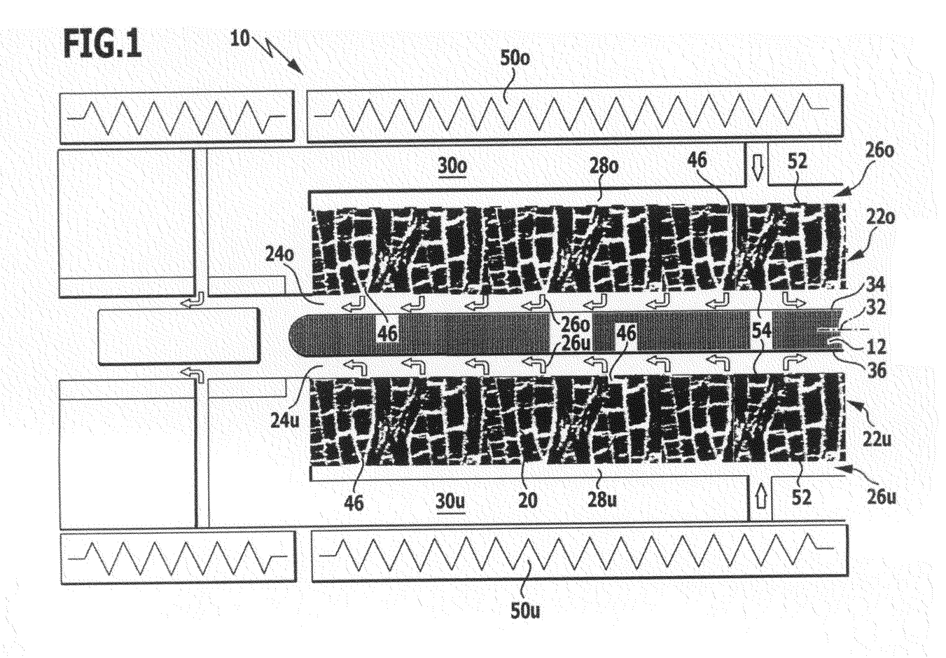

A first embodiment of an apparatus 10 according to the invention for the thermal treatment of a substrate 12, which is illustrated in FIG. 1 and extends parallel to a plane 32, comprises a space 20 accommodating a substrate which is located between two heating blocks 22 which likewise extend parallel to the plane 32, namely an upper heating block 22o and a lower heating block 22u, wherein in the space 20 accommodating the substrate the substrate 12 is guided relative to the heating blocks 22o and 22u by means of a cushion of gas 24o and 24u, respectively, so that the substrate 12 is located between the heating blocks 22o and 22u in a mechanically non-contact manner during the thermal treatment.

The cushions of gas 24o and 24u are generated by a stream 26o and 26u, respectively, of process gas which passes through the heating blocks 22o and 22u each time in a direction transverse to the plane 32, enters a distribution chamber 28o and 28u, respectively, between the heating block 22o and 22u, respectively, and a housing section 30o and 30u, respectively, enclosing the heating block 22o and 22u, respectively, from outside, the distribution chambers each being arranged on a side of the heating blocks 22o and 22u located opposite the substrate 12, and propagating in the distribution chamber 28o and 28u, respectively, over the extension of the heating block 22o and 22u, respectively, in a direction parallel to the plane 32.

The distribution chamber 28o and 28u, respectively, likewise extends over the entire extension of the heating block 22o and 22u, respectively, parallel to the plane 32 so that it is possible to have gas flowing through the heating blocks 22o and 22u in the area of their entire extension running parallel to the plane 32, each stream of gas, after it has passed from the distribution chamber 28o and 28u, respectively, to the space 20 accommodating the substrate, resulting, in the space 20 accommodating the substrate, in a diffuse stream of gas 26 for generating the cushion of gas 24o and 24u, respectively, and so the substrate 12 is contiguous to a cushion of gas 24o and 24u, respectively, which is formed uniformly in a direction parallel to the plane 32, over its entire extension in the direction of the plane 32 not only with an upper side 34 but also with an underside 36 and is guided by it.

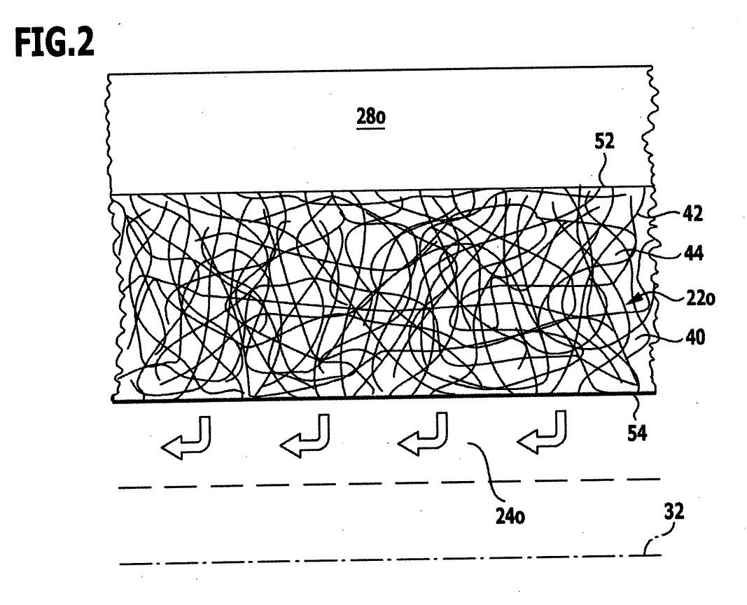

In order to generate such a cushion of gas 24 which is essentially uniform parallel to the plane 32, the respective heating block 22, in this case the heating block 22o, is designed, as illustrated in FIG. 2, as a fiber composite member 40, in which fibers 42 are present, on the one hand, as well as matrix material 44 between the fibers which connects the fibers 42 to one another.

Pores or cracks 46 are present in the matrix 44 and result due to the fact that the matrix 44 does not completely fill the spaces between the fibers 42 but rather leaves spaces free.

These pores and cracks 46 extend through the entire heating block 22 and so the gas can pass through these pores and cracks 46 and flow through the respective heating block 22 from its flat side 52 facing the distribution chamber 28 as far as its flat side 54 facing the substrate 12.

The percentage volume of the open pores and cracks 46 in the fiber composite member 40 is, for example, between approximately 1% and approximately 20%.

In one advantageous embodiment, the fiber composite member 40 is produced in that carbon fibers 42 and resin are mixed with one another and placed in a mold corresponding to the heating block 22.

Pyrolysis of the resin results in a member which consists of the carbon fibers 42 and the matrix 44 between the carbon fibers 42 which consists of carbon and has the cracks and pores 46.

A heating block 22 constructed in this manner is, in principle, suitable for generating the respective diffuse stream of gas 26 for forming the cushion of gas 24 on account of the cracks and pores 46.

If, however, the cushion of gas 24 is intended to be a reactive gas containing, for example, oxygen or other reactive chemical elements, a heating block 22 with exposed carbon accessible to the gas, whether this be carbon of the carbon fibers 42 or the matrix 44, would react with the gas.

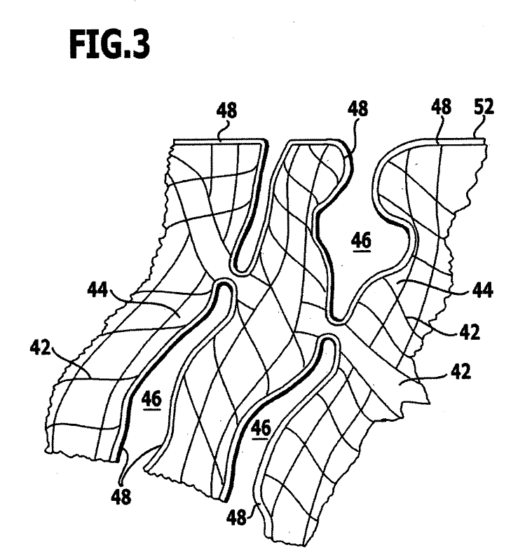

For this reason, as illustrated in FIG. 3, it is provided for all the exposed surfaces not only of the fiber composite member 40 itself, in particular, those of the flat sides 52 and 54 but also of the pores and cracks 46 to be covered, at least insofar as they can be subjected to the gas, at least with a layer 48 consisting of silicon carbide. This layer is obtainable, for example, in that following the pyrolysis of the members consisting of carbon fibers 42 and matrix 44 consisting of carbon a siliconization takes place which results in the silicon reacting with the carbon at the respective surfaces accessible to it to form silicon carbide and, therefore, providing all the surfaces of the heating block 22, which are accessible to the silicon and, therefore, also to the gas to be passed through later, in particular, in the area of the pores and cracks 46, as well, with the protective layer 48 consisting of silicon carbide.

Such a siliconization for forming the protective layer 48 may be preferably carried out in that a liquid siliconization takes place and, subsequently, a removal of the silicon which has not reacted to form the protective layer 48 and would, therefore, close the cracks and pores 46 at least partially.

Another possibility of siliconization is a siliconization by means of CVD, i.e., chemical vapor deposition or by means of CVI, i.e., chemical vapor infiltration, with which all the pores and cracks 46 accessible to a gas are reached and which therefore represent a possibility of generating the protective layer 48 in all the cracks and pores 46 later accessible to the gas, as well.

During the siliconization of the respective heating block 22, it is not necessary to convert all the carbon of the fibers 42 and the matrix 44 into silicon carbide since, as a result, the mechanical properties of the respective heating block 22 would be influenced since the mechanical/thermal damage tolerance of the carbon fibers 42 and the part of the matrix 44 consisting of carbon has an advantageous effect, in the case of the heating blocks 22 according to the invention, on the long-term stability and also the resistance to changes in temperature of the heating block 22.

In the case of the apparatus according to the invention, the heating blocks 22 are heated to a constant temperature, for example, a temperature of approximately 1200° C. and kept at this temperature in a controlled manner.

The heating blocks 22 have such a large thermal mass or heat storage capacity that they do not alter their temperature noticeably during insertion of the substrate 12 into the space 20 accommodating the substrate but simply heat up the substrate 12 on account of their inherent heat storage capacity, wherein the substrate 12 is heated up via a mechanically non-contact conduction of heat due to conduction of heat in the cushions of gas 24 on the part of the gas and so the substrate 12 has a good thermal coupling to the heating blocks as a result of the conduction of heat in the cushions of gas 24.

For this reason, the cushions of gas 24 preferably have a thickness of less than 300 μm, even better less than 200 μm in order to ensure an efficient conduction of heat between the heating blocks 22 and the substrate 12.

On account of the large mass of the heating blocks 22, it is not necessary to heat up and cool the heating blocks 22 quickly; on the contrary, the heating blocks 22 will merely be kept at a constant temperature and so only the heat losses will have to be compensated by subsequent heating of the heating blocks 22. Such subsequent heating of the heating blocks 22 will be brought about, for example, via heating devices 50o and 50u. The heating devices 50 can comprise, for example, lamps which heat up the respective housing sections 30o and 30u by way of radiation and, therefore, the heating blocks 22o and 22u, respectively, via them as a result of bodily heat contact or electrical resistance heating elements which rest on the housing sections 30o and 30u, respectively, and are in bodily heat contact with the heating blocks 22o and 22u via the housing sections.

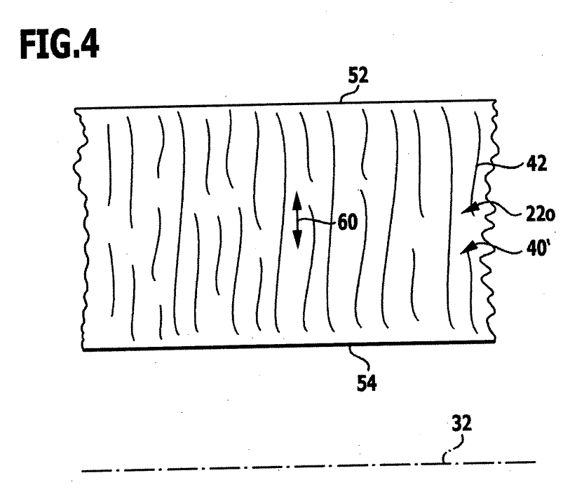

In contrast to the first embodiment, with which, as illustrated in FIG. 2, the fibers 42 extend in the fiber composite member 40 like a fleece without any preferential direction, it is provided in a second embodiment, illustrated in FIG. 4, for the fibers 42 in the fiber composite member 40′ to extend essentially along a preferential direction 60 which runs transversely, preferably at right angles to the plane 32 and, therefore, transversely, preferably at right angles to the sides 52 and 54, respectively, of the heating members 22 facing the distribution chamber 28 and the substrate 12.

With such a preferential direction of the fibers 42, the cracks and pores 46 are preferably formed along the fibers 42 and, therefore, in the preferential direction 60 and so it is possible, as a result, on account of the cracks 46 penetrating the heating blocks 42 along the preferential direction 60 of the fibers, to increase the size of the flow cross section for the gas flowing through the heating blocks 22 from the distribution chamber 28 to the space 20 accommodating the substrate and, therefore, to generate a sufficiently large stream of gas for the purpose of maintaining the cushion of gas 24 in the space 20 accommodating the substrate.

Since the cracks extending along the preferential direction 60 of the fibers 42 through the heating members 22 are, statistically, distributed over the entire extension of the heating members 22 in the direction of the plane 32, an optimum, more or less homogeneous, diffuse distribution of gas is achieved for forming the cushions of gas 24 in the space 20 accommodating the substrate.

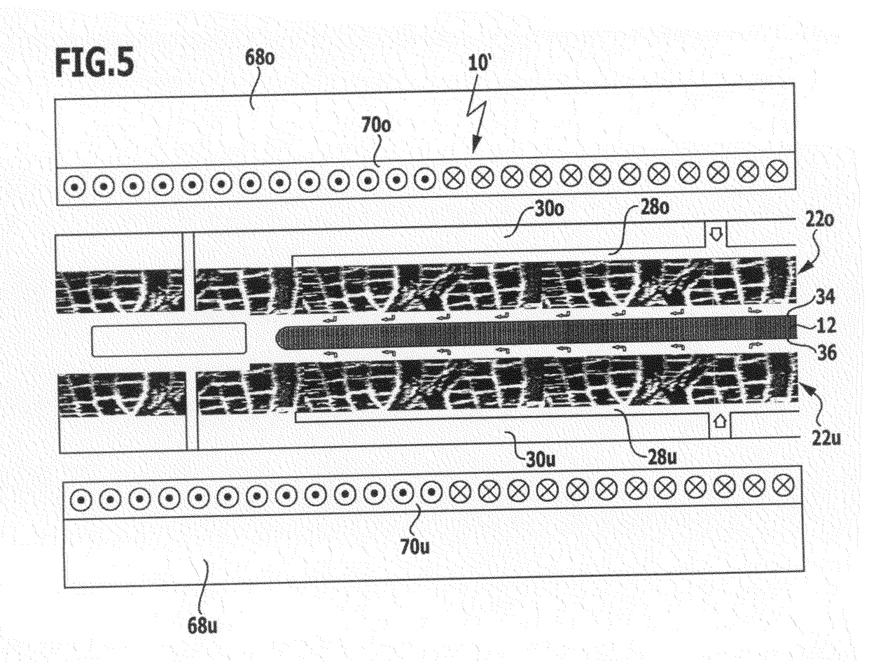

In a third embodiment of an apparatus 10′ according to the invention, illustrated in FIG. 5, those elements which are identical to the preceding embodiments are provided with the same reference numerals and so reference can be made in full to the comments on these elements with respect to their description.

In contrast to the embodiments described above, an inductor 68 is provided in the third embodiment as heating devices 50′ and its inductor coils 70o and 70u are arranged on a side of the heating blocks 22o and 22u, respectively, facing away from the substrate 12 and at a distance from them.

The inductor coils 70o and 70u of the inductor generate an alternate magnetic field which results in swirling flows in the protective layers 48 of the heating blocks 22 which consist of silicon carbide and these cause the heating blocks 22 to heat up.

As a result, it is possible in a simple manner to heat up the heating blocks 22 to the desired temperature in a mechanically non-contact manner by means of the alternate electromagnetic field of the inductor coils 70o and 70u and keep them at this temperature.

Since the heating blocks 22 must be subsequently heated, on account of their large heat capacity, only insofar as heat losses occur, the inductor coils 70o and 70u represent a simple possibility for heating the heating blocks 22 in a regulated manner.

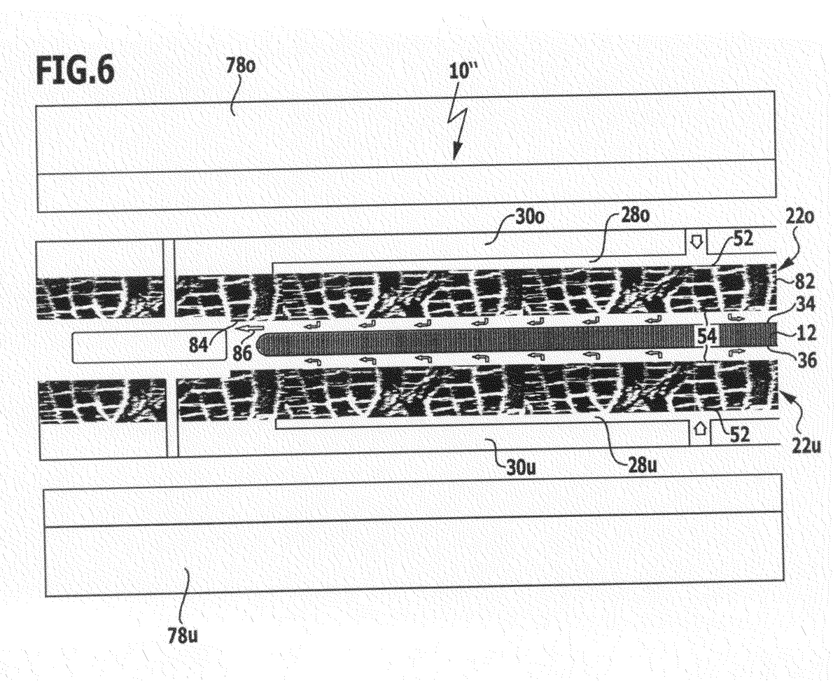

In a fourth embodiment, illustrated in FIG. 6, a microwave generator 78o and 78u is provided instead of the inductor coils 70o and 70u and this generates microwaves which are absorbed by the respectively associated heating blocks 22o and 22u and result in the entire, respective heating block 22o and 22u being heated up as a result of the fact that the protective layer 48, at least, consists of a ceramic material, in particular, silicon carbide.

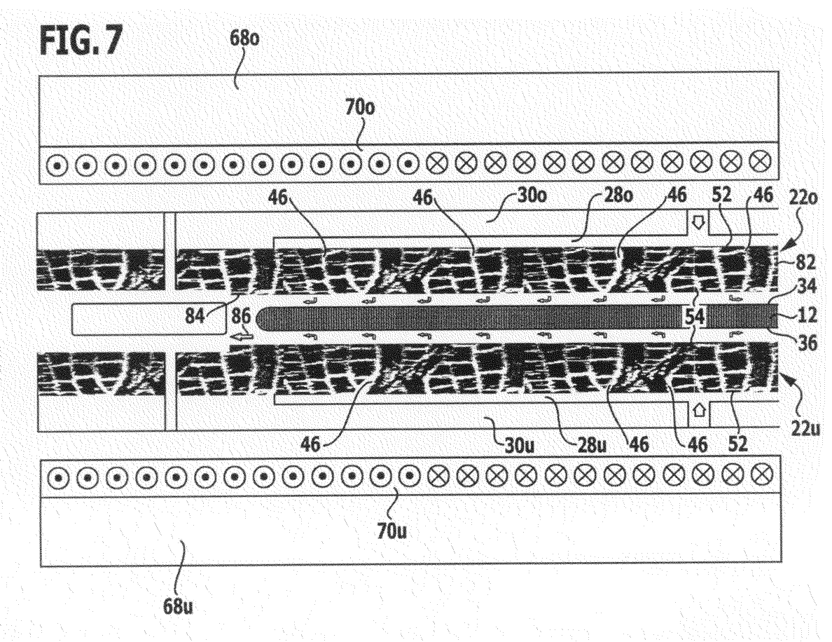

In a fifth embodiment, illustrated in FIG. 7, the heating blocks 22o and 22u are provided with pores and/or cracks 46 which vary with respect to their flow cross sections, wherein the flow cross section resulting by way of the pores and/or cracks 46 is greater in a central area 82 of the respective heating block 22 than in an outer area 84.

The flow cross section of the pores and/or cracks 46 in the central area 82 is, in particular, greater than the flow cross section of the pores and/or cracks 46 in the outer area 84 by at least a factor of 2, preferably by a factor of approximately 3 and so the flow velocity in the streams of gas 26o and 26u in a radial direction 86 in relation to the central area 82 is more or less constant since the stream of gas passing through the pores and/or cracks 46 in areas located radially outwards in relation to the central area 82 is added to the stream of gas resulting from the pores and/or cracks 46 located radially further inwards and, consequently, less gas is supplied as a result of a reduction in the flow cross sections of the pores and/or cracks in the outer area 84 for keeping the flow velocities of the streams of gas 26o and 26u essentially constant over the entire length of the substrate.

In this respect, the flow cross section of the pores and/or cracks can vary in one or more steps. It is, however, particularly favorable when the flow cross section of the pores and cracks 46 is reduced continuously, preferably linearly between the central area 82 and the respective outer area 84.

1. Heating block for an apparatus for the thermal treatment of a substrate, in particular, a semiconductor substrate, wherein the apparatus has a space accommodating the substrate and the heating block on at least one side of said space, the substrate being treatable thermally by means of said heating block in a mechanically non-contact manner,
the heating block being designed as a fiber composite member, the fiber composite member being designed with passages for a stream of gas passing through it from one flat side to the other flat side.

2. Heating block as defined in claim 1, wherein the fiber composite member has a material non-reactive to the stream of gas in the area of its essential surfaces bordering on the stream of gas.

3. Heating block as defined in claim 1, wherein the fiber composite member has ceramic material in the area of the surfaces bordering on the stream of gas.

4. Heating block as defined in claim 3, wherein the surfaces bordering on the stream of gas are the surfaces of ceramic layers of the fiber composite member.

5. Heating block as defined in claim 4, wherein the ceramic layers have a thickness of at least 1 μm.

6. Heating block as defined in claim 4, wherein the ceramic layers have a thickness of at the most 50 μm.

7. Heating block as defined in claim 1, wherein flow cross sections formed by the passages vary between a central area of the heating block and outer areas of the heating block.

8. Heating block as defined in claim 7, wherein the passages in the outer areas of the heating block have a smaller flow cross section than the passages in the central area of the heating block.

9. Heating block as defined in claim 1, wherein the passages are formed by pores and/or cracks in the fiber composite member.

10. Heating block as defined in claim 1, wherein the fibers in the fiber composite member extend approximately along a preferential direction.

11. Heating block as defined in claim 10, wherein the preferential direction extends transversely to flat sides of the heating block.

12. Heating block as defined in claim 1, wherein the ceramic material is silicon carbide.

13. Heating block as defined in claim 1, wherein the fiber composite member comprises carbon fibers.

14. Heating block as defined in claim 1, wherein the fiber composite member comprises material for the matrix.

15. Heating block as defined in claim 13, wherein the carbon is converted to silicon carbide at the surfaces bordering on the stream of gas.

16. Apparatus for the thermal treatment of substrates, in particular, semiconductor substrates, comprising a space accommodating the substrate and a heating block on at least one side of said space, the substrate being treatable thermally by means of said heating block in said space accommodating the substrate, the heating block being designed as a fiber composite member, the fiber composite member being designed with passages for a stream of gas passing through it from one flat side to the other flat side.

17. Apparatus as defined in claim 16, wherein the heating block is adapted to be heated up by a heating device in a mechanically non-contact manner.

18. Apparatus as defined in claim 17, wherein the heating block is adapted to be heated up by heat radiators.

19. Apparatus as defined in claim 17, wherein the heating block is adapted to be heated up by means of an inductor.

20. Apparatus as defined in claim 17, wherein the heating block is adapted to be heated up by a microwave generator.

21. Apparatus as defined in claim 16, wherein the heating block is adapted to be heated up by way of bodily thermal contact with the heating device.
